(19) United States
(12) Patent Application Publication
(10) Pub. No.: US 2008/0002232 A1
(43) Pub. Date: Jan. 3, 2008

(54) STARTUP CONTROLLER, STARTUP CONTROL METHOD, AND IMAGE FORMING APPARATUS

(76) Inventor: Yujin MORI, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/746,224

(22) Filed: May 9, 2007

(30) Foreign Application Priority Data
May 9, 2006 (JP) 2006-130670

(51) Int. Cl. H04N 1/00; G06F 1/00

(52) U.S. Cl. 358/401; 713/300

(57) ABSTRACT

A startup controller includes an engine controller, a controller, and a return signal controller. The engine controller is connected to a device that performs mechanical operation, and controls the mechanical operation of the device. The controller establishes communication with the engine controller, and controls process related to the device through the communication. The return signal controller is connected to the engine controller, and sends first information related to a startup state of the device to the engine controller. The engine controller controls the startup of the device based on the first information received from the return signal controller before the controller establishes the communication.

### CROSS-REFERENCE TO RELATED APPLICATIONS

The present document incorporates by reference the entire contents of Japanese priority document, 2006-130670 filed in Japan on May 9, 2006.

### BACKGROUND OF THE INVENTION

1. Field of the Invention

The present invention relates to a startup controller, a startup control method, and an image forming apparatus.

2. Description of the Related Art

Recently, there are image forming apparatuses referred to as multifunction product (MFP). The MFP has functions of apparatuses such as a printer, a copier, a facsimile machine, and a scanner. The MFP includes a display unit, a printing unit, and an imaging unit, and is installed with software corresponding to a printer, a copier, and a facsimile machine. The MFP is operated as a printer, a copier, a scanner, or a facsimile machine by changing over the software.

Such MFPs are required to consume less power during an image forming operation as well as in standby mode in which the image forming operation is not performed. To reduce power consumption, so-called “power saving mode” is used in which devices of a conventional MFP are divided into some blocks, and power supply to blocks other than minimum necessary blocks is suspended.

For example, Japanese Patent Application Laid-open No. 2001-285543 has proposed a technology in which information of execution history of image processing applications and operation modes and information of respective devices such as reading and printing are obtained and stored. Power saving control of devices is then performed by referring to these pieces of information and information that indicates correspondence between the operation modes of respective applications and necessity of power saving control of a plurality of devices.

The MFPs are required to provide less waiting time for users, by reducing the time taken to return from power saving mode to active mode, and the time taken to start up when a main power of the MFP is turned on.

For example, Japanese Patent Application Laid-open No. 2003-29954 has proposed a technology in which, when display processing of a print dialog on a display unit is performed, a sleep-mode-canceling request signal is transmitted to a printer via a communication apparatus and a signal transmission line, and a sleep-mode-canceling process is started according to the signal. Accordingly, the time for shifting from power saving mode (sleep mode) to active mode can be reduced, resulting in less waiting time for users.

However, in these conventional technologies, when an apparatus is started by turning on a main power, it is necessary to wait for startup of a controller that controls startup of an engine before activating each device (the engine). Therefore, there is a problem that a startup time of the whole apparatus depends on the startup time of the controller.

Note that, in the process of returning from power saving mode, the controller that controls the return has already been started, and basically, the problem as described above does not occur.

### SUMMARY OF THE INVENTION

It is an object of the present invention to at least partially solve the problems in the conventional technology.

According to an aspect of the present invention, a startup controller includes a first controller that is connected to a device that performs mechanical operation and controls the device, a second controller that establishes communication with the first controller and controls process related to the device through established communication, and an information sending unit that is connected to the first controller and sends first information related to a startup state of the device to the first controller. The first controller controls startup of the device based on the first information received from the information sending unit before the second controller establishes the communication.

According to another aspect of the present invention, an image forming apparatus includes an image forming unit that forms an image on an image carrier, a fixing unit that fixes the image formed by the image forming unit on a recording medium, and a startup controller that controls startup of the image forming unit and the fixing unit. The startup controller includes a first controller that controls mechanical operation of the image forming unit and the fixing unit, a second controller that establishes communication with the first controller and controls process related to the image forming unit and the fixing unit through established communication, and an information sending unit that is connected to the first controller and sends first information related to a startup state of the image forming unit and the fixing unit to the first controller. The first controller controls the startup of the image forming unit and the fixing unit based on the first information received from the information sending unit before the second controller establishes the communication.

According to still another aspect of the present invention, a startup control method that is applied to a startup controller including a first controller that is connected to a device that performs mechanical operation and controls the device, a second controller that establishes communication with the first controller and controls process related to the device through established communication, and an information sending unit that is connected to the first controller, includes the information sending unit sending information related to a startup state of the device to the first controller, and the first controller controlling startup of the device based on the first information received from the information sending unit before the second controller establishes the communication.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of an image forming apparatus according to a first embodiment of the present invention;

FIG. 2 is a flowchart of a return-signal setting process according to the first embodiment;

FIG. 3 is a flowchart of a startup process by a return signal according to the first embodiment;

FIG. 4 is a flowchart of a startup process by a command according to the first embodiment;

FIG. 5 is a schematic diagram for explaining an example of a signal and a command handled in a startup control process;

FIG. 6 is another schematic diagram for explaining an example of a signal and a command handled in the startup control process;

FIG. 7 is a block diagram of an image forming apparatus according to a second embodiment of the present invention;

FIG. 8 is a flowchart of a return-signal setting process according to the second embodiment;

FIG. 9 is a flowchart of a startup process by a return signal according to the second embodiment;

FIG. 10 is a schematic diagram for explaining an example of a signal and a command handled in a startup control process;

FIG. 11 is another schematic diagram for explaining an example of a signal and a command handled in the startup control process;

FIG. 12 is a flowchart of a startup process by a return signal in a modified example of the second embodiment;

FIG. 13 is still another schematic diagram for explaining an example of a signal and a command handled in the startup control process;

FIG. 14 is a block diagram of an image forming apparatus according to a third embodiment of the present invention;

FIG. 15 is a flowchart of a return-signal setting process according to the third embodiment;

FIG. 16 is a flowchart of a startup process by a return signal according to the third embodiment;

FIG. 17 is a schematic diagram for explaining an example of a signal and a command handled in a startup control process;

FIG. 18 is another schematic diagram for explaining an example of a signal and a command handled in the startup control process;

FIG. 19 is a schematic diagram for explaining another example of a signal and a command handled in the startup control process; and

FIG. 20 is another schematic diagram for explaining another example of a signal and a command handled in the startup control process.

### DETAILED DESCRIPTION OF THE PREFERRED EMBODIMENTS

Exemplary embodiments of the present invention are explained in detail below with reference to the accompanying drawings. In the following description, the present invention is applied to, for example, an image forming apparatus including a device such as an imaging unit that forms an image on an image carrier and a fuser that fuses the formed image on a recording medium.

An image forming apparatus according to a first embodiment of the present invention sends an electric signal indicating startup by turning on a main power or return from power saving mode to an engine controller before a startup request sent from a controller to control startup of an engine according to the electric signal.

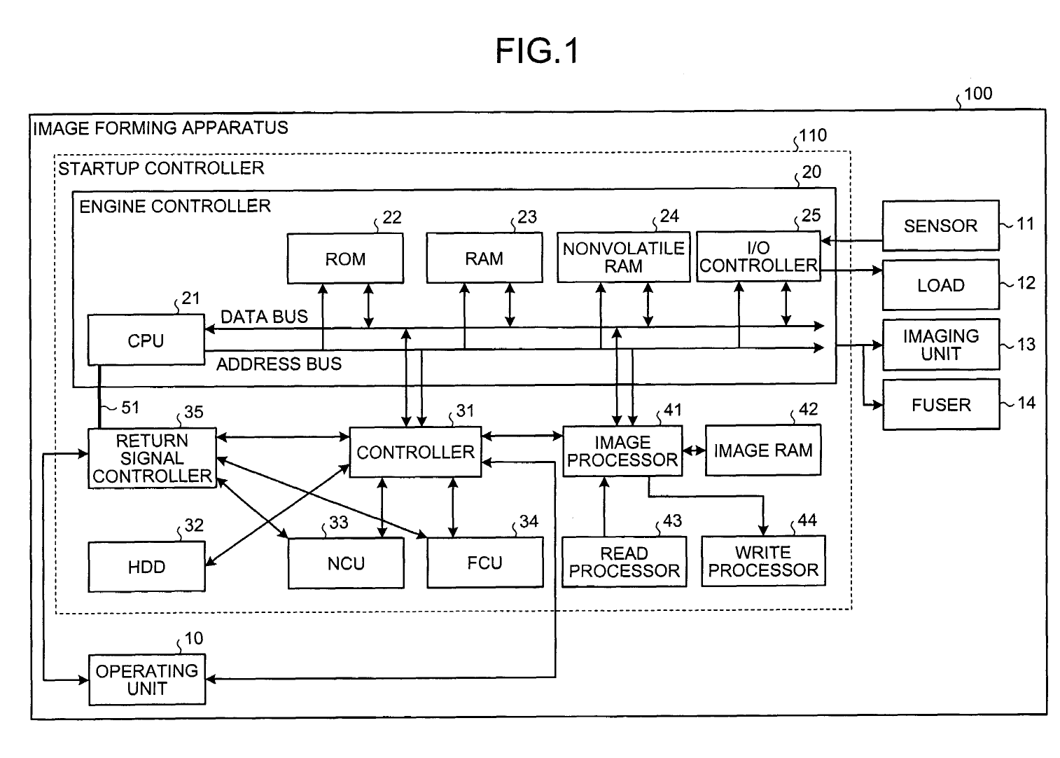

FIG. 1 is a block diagram of an image forming apparatus 100 according to the first embodiment. The image forming apparatus 100 includes an operating unit 10, a sensor 11, load 12, an imaging unit 13, a fuser 14, and a startup controller 110.

The operating unit 10 is a user interface that operates various switches and receives inputs on various operation screens. For example, the operating unit 10 receives ON/OFF of the main power by the switch, or a click on buttons instructing printing, FAX transfer, and the like.

The sensor 11 refers to various sensors in the image forming apparatus 100, such as a carrier path sensor that confirms abnormality in a carrier path, a unit connection detection sensor that confirms a unit connection state, and a door sensor that confirms an opening or closing state of a door.

The load 12 includes a motor, a solenoid, and the like that an input/output (I/O) controller 25, described later, controls by referring to input of the sensor 11.

The imaging unit 13 forms an image on a photoconductor drum, which is an image carrier, and includes the photoconductor drum, a charger, a development unit, a transfer unit, and a separating unit.

The fuser 14 fuses the image formed by the imaging unit 13 on a recording medium, and includes a fuser roller and a pressure roller.

The imaging unit 13 and the fuser 14 correspond to the engine, whose operation is controlled by an engine controller 20 described later. The engine is not limited to the imaging unit 13 and the fuser 14, and any device used for image formation such as the scanner (not shown) and a FAX unit (not shown) can correspond thereto.

The startup controller 110 controls startup of the engines that perform a mechanical operation related to image processing such as the imaging unit 13 and the fuser 14. The startup controller 110 includes the engine controller 20, a controller 31, a hard disk drive (HDD) 32, a network control unit (NCU) 33, a facsimile control unit (FCU) 34, a return signal controller 35, an image processor 41, an image random access memory (image RAM) 42, a read processor 43, and a write processor 44.

The respective components in the startup controller 110 can be formed on a single substrate or can be formed separately on a plurality of substrates. For example, a central processing unit (CPU) 21, the controller 31, and the return signal controller 35 can be formed, respectively, as an independent processor, and provided on the respective separate substrates.

The engine controller 20 controls the engine that performs the mechanical operation related to the image processing such as the imaging unit 13 and the fuser 14, and includes the CPU 21, a read only memory (ROM) 22, a RAM 23, a nonvolatile RAM 24, and the I/O controller 25.

The CPU 21 is a processor that executes an engine control process in the engine controller 20. The ROM 22 stores a program for operating the CPU 21. The RAM 23 temporarily stores data for the program. The nonvolatile RAM 24 stores an adjustment value related to control and timing, and a set value for a registered copy mode and the like. The I/O controller 25 controls the load 12 and the like based on the input from the sensor 11.

The controller 31 controls the entire image forming apparatus 100 and controls inputs from the drawing, communication, and the operating unit 10. The controller 31 controls various types of processing related to the image processing, by using communication established with the engine controller 20.

When the main power of the image forming apparatus 100 is turned on, initialization of the engine controller 20 and the controller 31 is complete, and the image forming apparatus 100 is in a ready state capable of performing an image forming process such as copying. The initialization includes establishment of communication via a bus (data bus and address bus) between the controller 31 and the CPU 21. After establishment of the communication, the controller 31 and the CPU 21 can perform control by various commands such as an engine-startup request command.

The HDD 32 is a storage that stores image data, programs, font data, and forms.

The NCU 33 communicates with an external device (not shown), and the FCU 34 performs fax transfer via a public line. For example, upon receipt of a print request or a facsimile from the external device, the controller 31 converts the received image data to print data. The print data is temporarily stored in the HDD 32, and transferred to the write processor 44 via the image processor 41, thus the image data is output.

The return signal controller 35 refers to a user operation using the operating unit 10 or information such as a print request received by the NCU 33 or the FCU 34, to generate a signal indicating the startup state of the engine, and sends the signal to the engine controller 20.

Specifically, the return signal controller 35 generates a return signal (hereinafter, “signal 1”), which is a signal having different strength (high or low) corresponding to startup by main power ON or return from the power saving mode in which power consumption is suppressed than that in the normal operation at the time of standby. Either “main power ON” or “return from power saving mode” is allocated to signal 1 corresponding to the strength.

For example, when setting of signal 1 corresponding to the default strength (for example, low) is determined as “main power ON”, and the apparatus is started by turning on the main power, signal 1 is set to the default strength in an initialization process of the return signal controller 35. Accordingly, signal 1 corresponding to startup by turning on the main power can be generated.

In the case of returning from the power saving mode, because the return signal controller 35 has been already started, and information of a user operation or receipt of a process request via the network can be obtained, signal 1 can be set to “return from power saving mode” under a condition that these pieces of information are obtained.

The return signal controller 35 is connected to the CPU 21 by a data line 51 to send the generated signal 1 to the CPU 21 via the data line 51.

The image processor 41 performs processing of the read image data. Specifically, the image processor 41 performs MTF correction, scaling, and image quality correction of the image data according to various processing modes set by the operating unit 10, and stores the image data in the HDD 32 via the image RAM 42 and the controller 31.

When an electronic sort function for making a plurality of copies is used, the image processor 41 copies the image data from the HDD 32 to the image RAM 42 at the time of performing a copy operation for the second copy and onward, and performs the copy operation using the copied image data, thereby realizing the electronic sort function. The stored image data is also used for a recovery operation when the paper is jammed.

The engine controller 20 and the controller 31 are connected with each other via the image processor 41, and in the image processing, not only the image data but also a control signal and a status signal are transferred therebetween via the image processor 41.

The image RAM 42 stores the image data, which is a target of the image processing performed by the image processor 41.

The read processor 43 reads the image data scanned by the scanner (not shown). The write processor 44 performs write according to the timing of the fed paper.

A startup control process performed by the image forming apparatus 100 is explained next. In the startup control process, a return-signal setting process for setting the return signal, a startup process by a return signal, and a startup process by a command are operated in parallel. However, the respective processes are separately explained below.

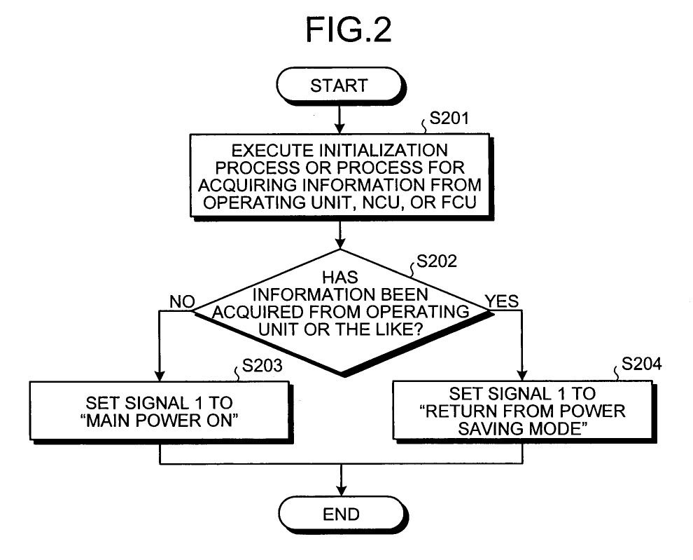

FIG. 2 is a flowchart of the return-signal setting process according to the first embodiment. The return-signal setting process is performed when the main power is turned on, or upon receipt of the user operation or the like in the power saving mode, and the return signal controller 35 controls the execution.

The return signal controller 35 executes an initialization process or a process for acquiring information from the operating unit 10, the NCU 33, and the FCU 34 (step S201). That is, when the apparatus is started by turning on the main power, because initialization of the return signal controller 35 itself is required, the initialization process is performed. When the apparatus has already been started, the information acquisition process is executed. In the information acquisition process, the return signal controller 35 acquires information such as an operation request and a processing request from the user received by the operating unit 10, the NCU 33, or the FCU 34.

The return signal controller 35 determines whether information has been acquired from the operating unit 10, the NCU 33, or the FCU 34 (step S202). When the initialization process is to be performed, because the information is not acquired (NO at step S202), the return signal controller 35 sets signal 1 to “main power ON”, which is a default value (step S203). It can be configured such that in the initialization process, it is not determined whether information has been acquired, and signal 1 can be simply set to the default value, “main power ON”.

When the information is acquired (YES at step S202), the return signal controller 35 sets signal 1 to “return from power saving mode” (step S204).

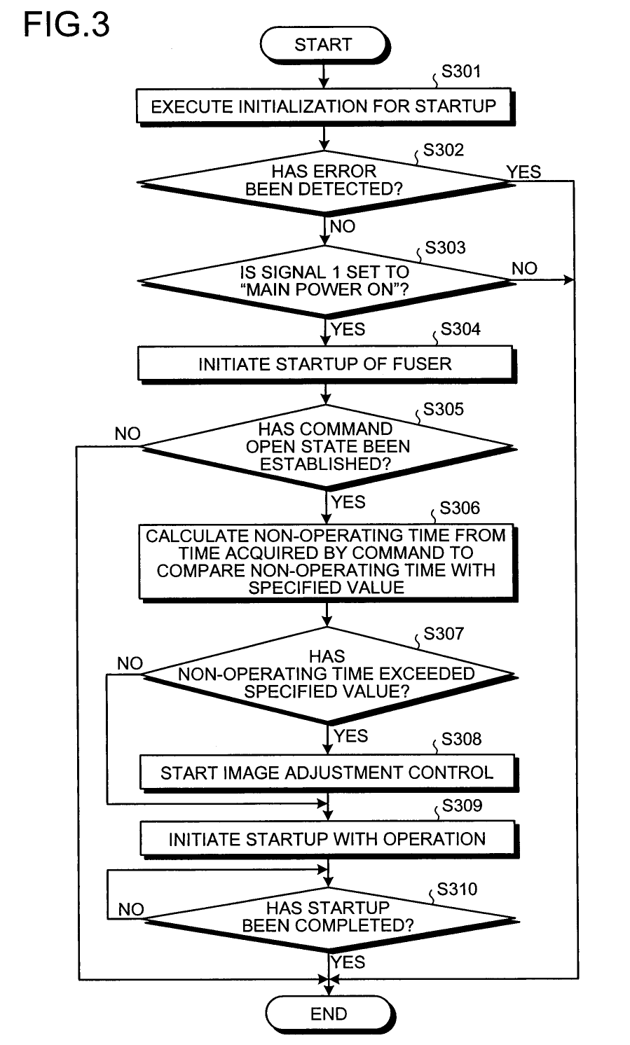

The startup process by a return signal executed by the engine controller 20 is explained next. FIG. 3 is a flowchart of the startup process by a return signal according to the first embodiment.

The CPU 21 in the engine controller 20 executes initialization for startup (step S301). Specifically, the CPU 21 acquires information input from the sensor 11 from the I/O controller 25, and acquires an adjustment value from the nonvolatile RAM 24.

The CPU 21 then determines whether an error has been detected (step S302). Specifically, the CPU 21 detects an error such as abnormality in the carrier path, abnormal unit connection, and abnormal opening or closing of the door from the input information acquired from the sensor 11.

When an error is detected (YES at step S302), the startup process by a return signal is finished. When an error is not detected (NO at step S302), the CPU 21 confirms the content of signal 1 (step S303). The CPU 21 asserts a value set in the return-signal setting process to acquire signal 1. Specifically, the CPU 21 first determines whether signal 1 is set to “main power ON” (step S303).

When signal 1 is not set “main power ON”, that is, signal 1 is set to “return from power saving mode” (NO at step S303), the startup process by a return signal is finished. It is because in this case there is no need to wait for startup of the controller 31, and therefore an engine startup process can be started early by the startup process by a command.

When signal 1 is set to “main power ON” (YES at step S303), the CPU 21 initiates startup of the fuser 14 (step S304).

The CPU 21 then determines whether command open state has been established (step S305). When the command open state has not been established (NO at step S305), the startup process by a return signal is finished. The command open state represents a state where communication between the controller 31 and the CPU 21 is established in the initialization process, and transfer of commands becomes possible. Basically, command-open process starts parallel with the startup process by a return signal.

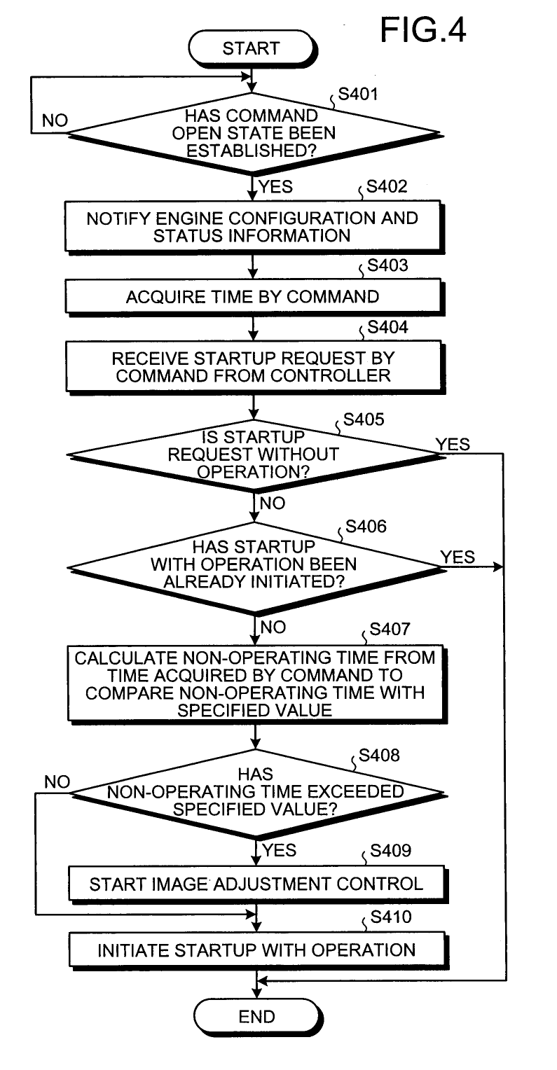

Therefore, when the opening process of the command has not been completed at a point in time of step S305, the startup process by a return signal is finished at that point, and when the opening process of the command has been completed, it means that processing at step S306 and onward including the processing using the command is continued. When the opening process of the command has not been completed and the startup process by a return signal is finished, remaining part of the startup process is executed by the startup process by a command (see FIG. 4, described later), which is processed in parallel.

When it is determined that the command open state has been established (YES at step S305), the CPU 21 calculates a non-operating time of the engine from the time acquired by the command, and compares the non-operating time with a predetermined specified value (step S306).

Specifically, the CPU 21 requests acquisition of the current time to the controller 31 by the command, and compares the time replied from the controller 31 with pre-stored last operation-completion time of the engine to calculate the non-operating time of the engine. The non-operating time represents a time having passed without an image forming operation or an image adjusting operation being performed by the engine.

The CPU 21 determines whether the calculated non-operating time has exceeded the specified value (step S307), when the non-operating time has exceeded the specified value (YES at step S307), the CPU 21 starts the image adjustment control (step S308). The image adjustment control represents an adjustment process of the set value by eliminating influences of variable factors such as temperature and humidity of an environment in which the image forming apparatus 100 is installed and optimizing the image formed by the imaging unit 13. It is because when the non-operating time exceeds the specified value, the influences of variable factors increases, thereby causing degradation of the image quality.

When it is determined that the non-operating time does not exceed the specified value at step S307 (NO at step S307), or the image adjustment control is started, the CPU 21 initiates startup with an operation (step S309). The startup with an operation means startup including a warm-up operation of the imaging unit 13.

The CPU 21 determines whether the startup has been completed (step S310), and when the startup has not been completed (NO at step S310), the CPU 21 returns to the determination process to repeat the process. When the startup has been completed (YES at step S310), the CPU 21 finishes the startup process by a return signal.

The startup process by a command executed by the engine controller 20 is explained next. FIG. 4 is a flowchart of the startup process by a command according to the first embodiment.

The CPU 21 determines whether the command open state has been established (step S401). When the command open state has not been established (NO at step S401), the CPU 21 repeats determination until the command open state has been established.

When the command open state has been established (YES at step S401), the CPU 21 notifies the controller 31 of the engine configuration and status information (step S402).

The CPU 21 then executes acquisition of time by a command (step S403). Specifically, the CPU 21 requests the controller 31 to acquire the current time by a command, thereby acquiring the time replied from the controller 31.

The CPU 21 receives the startup request by a command sent from the controller 31 (step S404). Subsequently, the CPU 21 determines whether the received command is a startup request without an operation (step S405). The startup command without an operation represents a request for activating other parts/functions without operating the imaging unit 13.

For example, a data processing request has been received from the network. The requested processing is to store image data in the memory, and in addition to this, a startup request command without an operation is sent from the controller 31, in a state where processing requiring an operation of the imaging unit 13, such as printing, does not accompany thereto.

When the startup request is without an operation (YES at step S405), because startup of the imaging unit 13 is not required, the startup process by a command finishes.

When the startup request is not the one without an operation, that is, when it is a startup request with an operation (NO at step S405), the CPU 21 determines whether the startup with an operation has been already started (step S406). When the startup has been initiated (YES at step S406), the CPU 21 finishes the startup process by a command.

When the startup has not been initiated (NO at step S406), the CPU 21 calculates the non-operating time of the engine from the time acquired by a command to compare the non-operating time with the preset specified value (step S407).

The CPU 21 determines whether the calculated non-operating time has exceeded the specified value (step S408). When the non-operating time has exceeded the specified value (YES at step S408), the CPU 21 starts the image adjustment control (step S409).

When it is determined that the non-operating time does not exceed the specified value (NO at step S408), or the image adjustment control has been started, the CPU 21 initiates startup with an operation (step S410) and finishes the startup process by a command. When startup of the fuser 14 has not been initiated yet, startup of the fuser 14 is initiated together with startup of the imaging unit 13 at step S410.

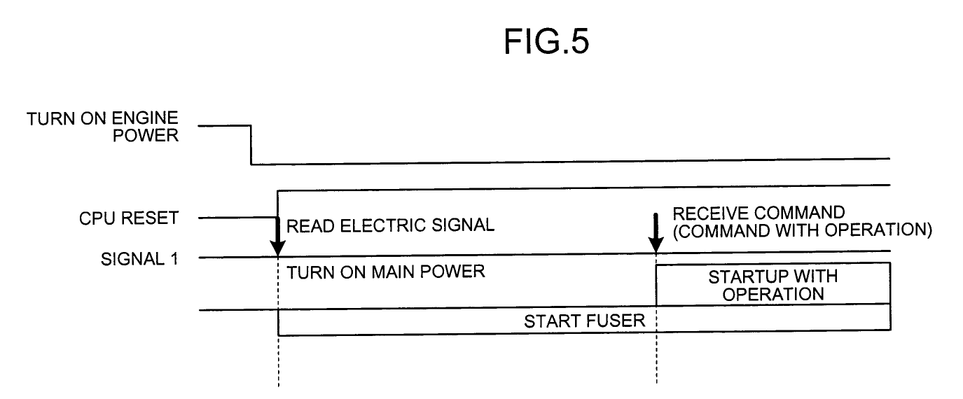

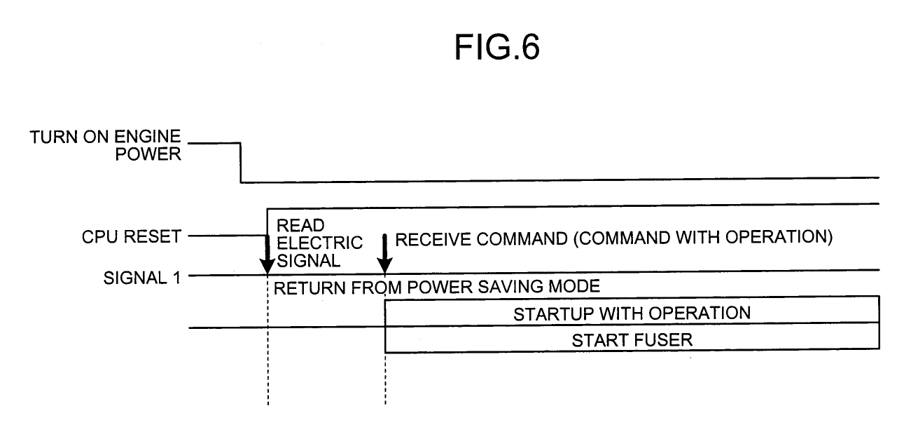

A specific example of the engine-startup control process performed by the image forming apparatus 100 is explained next. FIGS. 5 and 6 are schematic diagrams for explaining an example of a signal and a command handled in the startup control process.

FIG. 5 is an example of the signal and the command when the apparatus is started by turning on the main power. As shown in FIG. 5, after a power of the engine is turned on to reset the CPU 21, the CPU 21 reads signal 1 set by the return signal controller 35.

In this example, because “main power ON” is set in signal 1, the CPU initiates startup of the fuser 14 (YES at step S303, step S304).

Thereafter, when it is assumed that the command open state has been established and a command requesting startup with an operation is received (NO at step S405), the CPU 21 initiates startup with an operation (step S410).

Thus, conventionally, after initialization of the controller 31 is complete, and communication between the controller 31 and the CPU 21 has been established, startup of the imaging unit 13 and the fuser 14 is initiated by a command request. On the other hand, according to the method of the first embodiment, upon receipt of signal 1, the CPU 21 can initiate startup of the fuser 14 immediately. Accordingly, a startup time is reduced, thereby realizing reduction of the waiting time of the user.

FIG. 6 is an example of the signal and the command at the time of returning from the power saving mode. As shown in FIG. 6, after the power of the engine is turned on due to the return from the power saving mode to reset the CPU 21, the CPU 21 reads signal 1 set by the return signal controller 35.

In this example, because “return from power saving mode” is set in signal 1, the CPU 21 does not initiate startup of the fuser 14 (NO at step S303). On the other hand, when the command open state has been established and a command requesting startup with an operation is received (NO at step S405), the CPU 21 concurrently initiates startup of the imaging unit 13 (startup with an operation) and the fuser 14 (step S410).

Thus, in the case of return from the power saving mode, the command open state can be established at an early stage between the CPU 21 and the controller 31. Therefore, the CPU 21 can execute startup of the engine according to the startup process by a command (see FIG. 4), as well as receipt of the command.

There is another method of solving the above problem by turning on the main power or starting startup of the fuser 14 unconditionally at the time of return from the power saving mode. According to the method of the first embodiment, however, it can be set such that startup of the fuser 14 is not performed in the case of return from the power saving mode, according to determination based on signal 1. Accordingly, unnecessary startup process can be avoided, thereby enabling more appropriate startup control.

According to the first embodiment, the image forming apparatus can send an electric signal indicating startup by turning on the main power or return from the power saving mode to the engine controller before a startup request sent from the controller, to control startup of the engine according to the electric signal. Accordingly, engine startup can be initiated without waiting for a request from the controller, thereby reducing the startup time to reduce the waiting time of the user.

Moreover, the above effect can be obtained only by adding one signal line 51. Accordingly, even when resources are limited as in a small image forming apparatus, the waiting time can be reduced with a necessity minimum and lost-cost configuration.

An image forming apparatus according to a second embodiment of the present invention further sends an electric signal indicating whether startup needs an operation (warming up) of the imaging unit, to control the startup of the engine according to the electric signal.

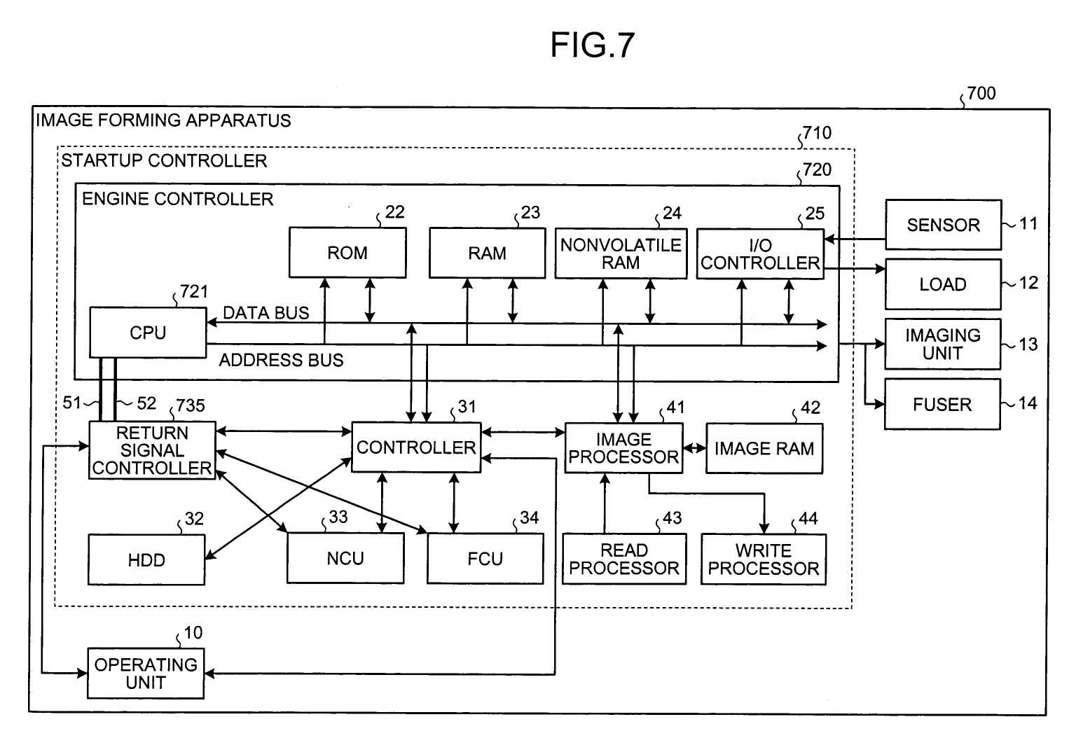

FIG. 7 is a block diagram of an image forming apparatus 700 according to the second embodiment. The image forming apparatus 700 includes the operating unit 10, the sensor 11, the load 12, the imaging unit 13, the fuser 14, and a startup controller 710.

In the second embodiment, the function of the startup controller 710 is different from that of the first embodiment. Specifically, functions of a CPU 721 included in an engine controller 720 in the startup controller 710 and a return signal controller 735 in the startup controller 710 are different from those of the first embodiment. Otherwise, the image forming apparatus 700 has the same configuration and operates in the same manner as the image forming apparatus 100 previously described in connection with FIG. 1. Accordingly, like reference numerals refer to like parts, and the same explanations are not repeated.

It is different from the return signal controller 35 according to the first embodiment that the return signal controller 735 further generates a return signal (hereinafter, “signal 2”) having a different strength corresponding to startup requiring startup of the imaging unit 13 (startup with an operation) or startup not requiring startup of the imaging unit 13 (startup without an operation). Either “startup with operation” or “startup without operation” is allocated to signal 2 corresponding to the strength.

For example, when setting of signal 2 corresponding to the default strength (for example, low) is determined as “startup without operation” and the apparatus is started by turning on the main power, signal 2 is set to the default strength in the initialization process of the return signal controller 735.

In the case of returning from the power saving mode, the return signal controller 735 has been already started, and information of a user operation or receipt of a process request via the network can be obtained. Therefore, the return signal controller 735 refers to these pieces of information, and determines whether the process request requires startup of the imaging unit 13, thereby setting “startup with operation” or “startup without operation”.

The return signal controller 735 is connected to the CPU 721 not only by the data line 51 for sending signal 1 but also by a data line 52 for sending signal 2.

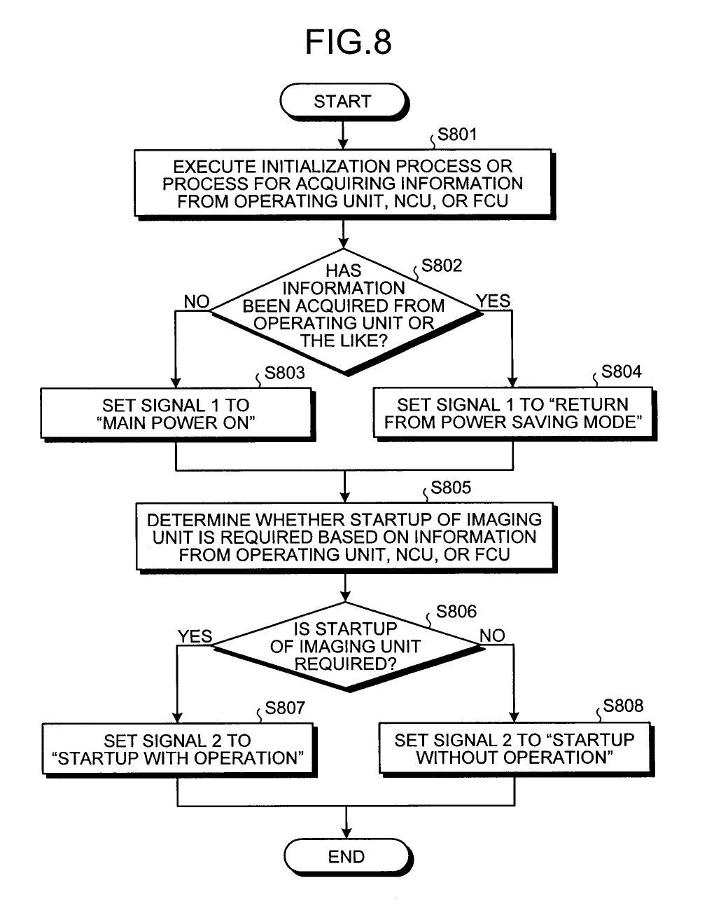

A return-signal setting process performed by the image forming apparatus 700 is explained next. FIG. 8 is a flowchart of the return signal-setting process according to the second embodiment.

The setting process of signal 1 at steps S801 to S804 is the same as the process at steps S201 to S204 previously described in the first embodiment, and therefore, explanations thereof are omitted.

After having set signal 1, the return signal controller 735 determines whether startup of the imaging unit 13 is required based on the information from the operating unit 10, the NCU 33, or the FCU 34 (step S805).

The return signal controller 735 determines whether startup of the imaging unit 13 is required (step S806). When startup of the imaging unit 13 is required (YES at step S806), the return signal controller 735 sets signal 2 to “startup with operation” (step S807).

When startup of the imaging unit 13 is not required (NO at step S806), the return signal controller 735 sets signal 2 to “startup without operation” (step S808).

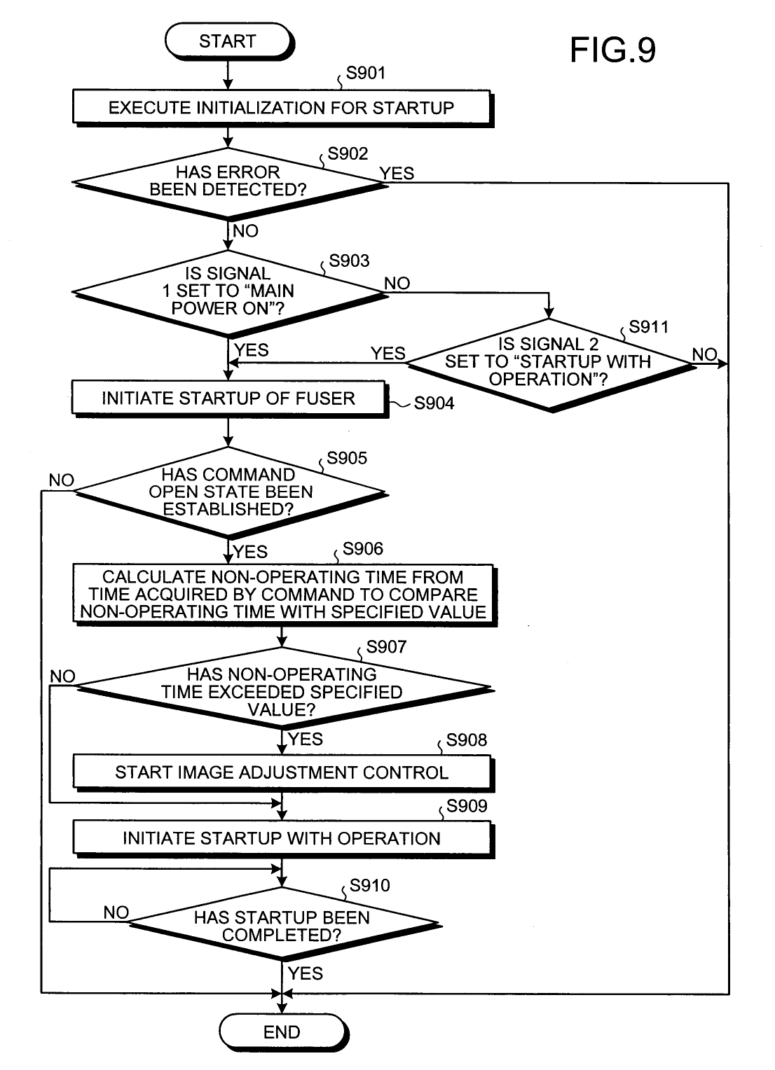

The startup process by a return signal is explained next. FIG. 9 is a flowchart of the startup process by a return signal according to the second embodiment.

The initialization process and the error detection process at steps S901 and S902 are the same as those at steps S301 and S302 previously described in the first embodiment. Therefore, explanations thereof are omitted.

When an error is not detected (NO at step S902), the CPU 721 determines whether signal 1 is set to “main power ON” (step S903). When signal 1 is not set to “main power ON” (NO at step S903), the CPU 721 further determines whether signal 2 is set to “startup with operation” (step S911).

When signal 2 is set to “startup with operation” (YES at step S911), the CPU 721 initiates startup of the fuser 14.

The command open-determination process, the image adjustment control process, and the startup starting process at steps S905 to S910 are the same as those at steps S305 to S310 previously described in the first embodiment. Therefore, explanations thereof are omitted.

When signal 2 is not set to “startup with operation” (NO at step S911), the startup process by a return signal finishes because startup of the imaging unit 13 and the fuser 14 is not required.

For example, a case that information related to the configuration of the engine and setting information such as the adjustment value and a count value related to service life of the parts are acquired from an external device corresponds to “return from power saving mode” and “startup without operation”.

In the second embodiment, an example of using signal 1 and signal 2 has been explained. However, only signal 2 can be used without using signal 1. In this case, the determination process of signal 2 at step S911 is executed instead of step S903, to determine whether to initiate startup of the fuser 14 or finish the process based on the determination result.

Thus, according to the second embodiment, it can be determined whether startup of the imaging unit 13 is required by referring to signal 2. Therefore, even in the power saving mode, startup of the fuser 14 can be initiated early. Accordingly, the startup time can be reduced, and reduction of the waiting time of the user can be realized.

The startup process by a command according to the second embodiment is the same as that according to the first embodiment shown in FIG. 4, and therefore, explanations thereof are omitted.

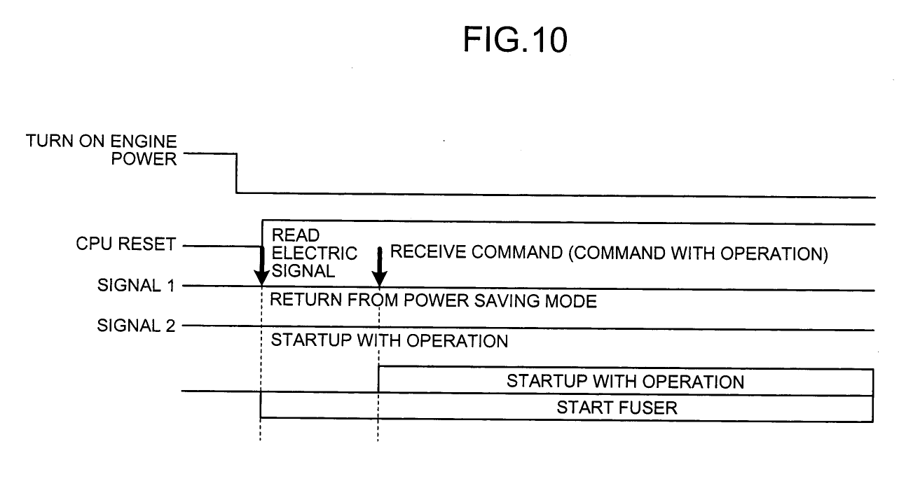

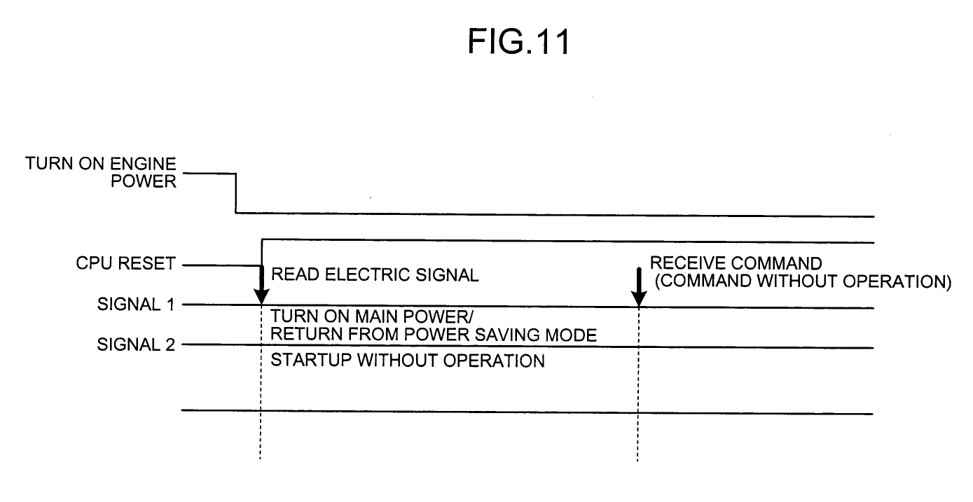

A specific example of the engine-startup control process performed by the image forming apparatus 700 is explained next. FIGS. 10 and 11 are schematic diagrams for explaining an example of a signal and a command handled in the startup control process.

FIG. 10 is an example of the signal and the command in the case of return from the power saving mode. As shown in FIG. 10, after the power of the engine is turned on due to return from the power saving mode to reset the CPU 721, the CPU 721 reads signal 1 and signal 2 set by the return signal controller 735.

In this example, because signal 1 is set to “return from power saving mode”, the CPU 721 performs determination of signal 2 (NO at step S903, step S911). In this example, because signal 2 is set to “startup with operation”, startup of the fuser 14 is initiated (YES at step S911, step S904).

Thereafter, when it is assumed that the command open state has been established and a command requesting startup with an operation is received (NO at step S405), the CPU 721 initiates startup with an operation (step S410).

Thus, even in the case of return from the power saving mode, the CPU 721 can initiate startup of the fuser 14 early by determining the setting of signal 2.

FIG. 11 is an example of the signal and the command in the case of main power ON or return from power saving mode, and startup without an operation. For example, when the engine is returned from the power saving mode, though printing is not required, signal 1 is set to “return from power saving mode” and signal 2 is set to “startup without operation”, which corresponds to the example of FIG. 11.

As shown in FIG. 11, after the power of the engine is turned on to reset the CPU 721, the CPU 721 reads signal 1 and signal 2 set by the return signal controller 735.

In this example, because signal 2 is set to “startup without operation”, the CPU 721 finishes the process without activating the fuser 14 (NO at step S911).

Thereafter, when it is assumed that the command open state has been established and a command requesting startup without an operation is received (YES at step S405), the CPU 721 does not start the imaging unit 13 and the fuser 14, because the startup thereof is not required.

Thus, it can be determined whether startup with an operation is required by referring to signal 2, and therefore start of the unnecessary startup process can be avoided.

A modified example of the second embodiment is explained next. In the second embodiment, at the time of startup by main power ON, the imaging unit 13 is started after waiting for establishment of the command open state, as in the first embodiment (step S909, step S309).

This is because in the case of startup by main power ON, the non-operating time cannot be calculated unless the time acquisition by a command is executed after establishment of the command open state, and therefore, it cannot be determined whether the image adjustment control based on the non-operating time is required. On the other hand, in the modified example, the startup process of the imaging unit 13 excluding the image adjustment control operation is started early, to calculate the non-operating time after the command open state has been established, thereby determining whether the image adjustment control is required.

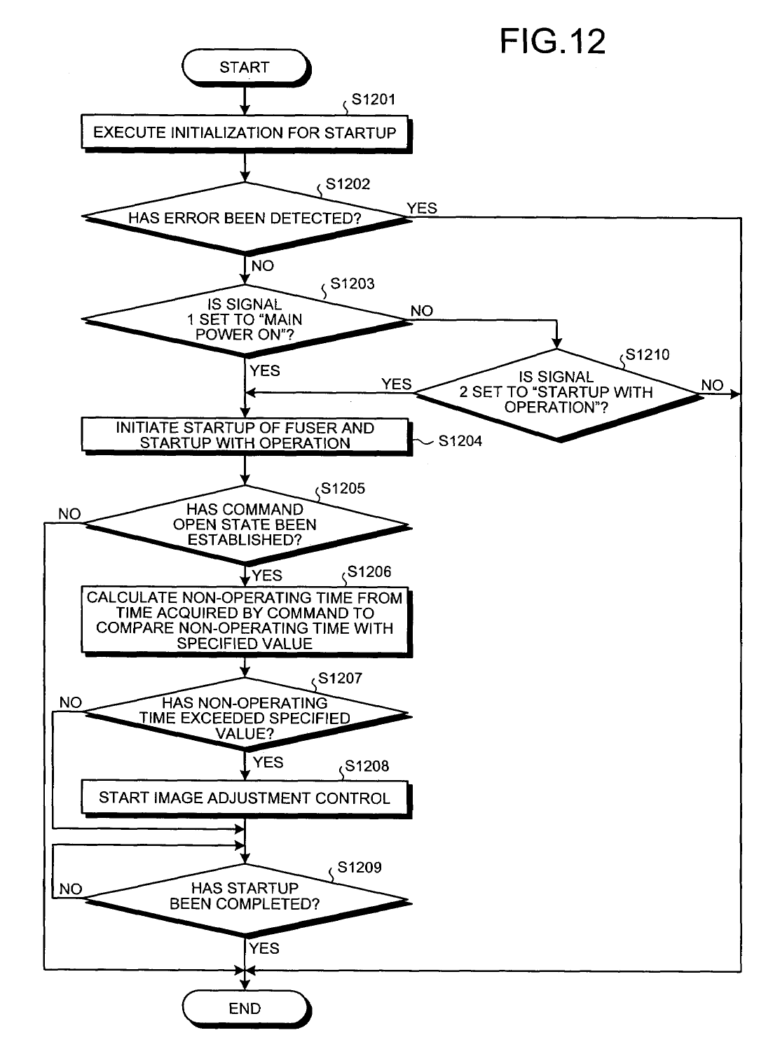

FIG. 12 is a flowchart of the startup process by a return signal in the modified example of the second embodiment.

The initialization process, the error detection process, and the signal determination process at steps S1201 to S1203 and step S1210 are the same as those at steps S901 to step S903 and step S911 shown in FIG. 9. Therefore, explanations thereof are omitted.

In the modified example, when signal 1 is set to “main power ON” (YES at step S1203), and signal 2 is set to “startup with operation” (YES at step S1210), it is different from FIG. 9 in that not only the fuser 14 but also the imaging unit 13 are started.

The command open-determination process and the image adjustment-control process at steps S1205 to S1208 are the same as those at steps S905 to S908 in FIG. 9. Therefore, explanations thereof are omitted.

In the modified example, it is different from the second embodiment in that a starting process of startup with an operation is not executed because startup of the imaging unit 13 has already been started (step S909 in FIG. 9 is omitted).

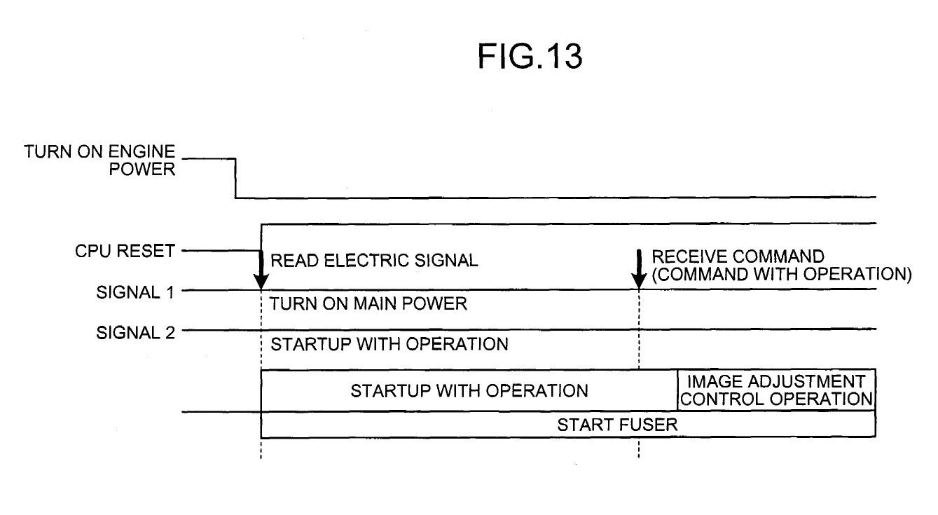

A specific example of the engine-startup control process according to the modified example is explained next. FIG. 13 is a schematic diagram for explaining an example of a signal and a command handled in the startup control process.

In this example, because signal 1 is set to “main power ON”, the CPU 721 initiates startup of the imaging unit 13 together with startup of the fuser 14 (YES at step S1203, step S1204).

Thereafter, when it is assumed that the command open state has been established and a command requesting startup with an operation is received (NO at step S405), the CPU 721 initiates startup with an operation (step S410). At this time, if it is determined that the image adjustment control operation is required based on the determination of the non-operating time, the image adjustment control operation is started from this point in time.

Thus, according to the modified example, it can be avoided that the overall startup of the imaging unit 13 is delayed due to a delay of starting the image adjustment control operation. Accordingly, the startup time can be reduced, and reduction of the waiting time of the user can be realized.

According to the second embodiment, the image forming apparatus can further send an electric signal indicating whether startup requires an operation of the imaging unit, and can control startup of the engine according to the electric signal. Therefore, the operation of the imaging unit can be started without waiting for a request from the controller. Accordingly, the startup time can be reduced, and reduction of the waiting time of the user can be realized.

An image forming apparatus according to a third embodiment of the present invention further sends an electric signal indicating whether the non-operating time of the engine has exceeded a predetermined threshold, to control the startup of the engine according to the electric signal.

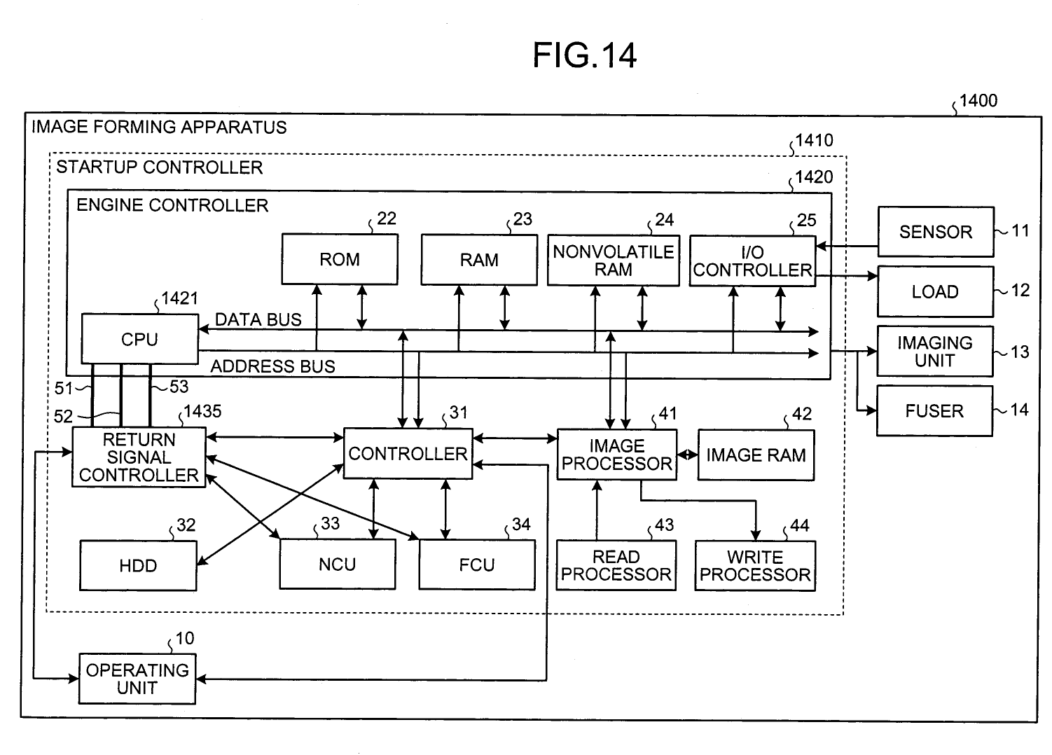

FIG. 14 is a block diagram of an image forming apparatus 1400 according to the third embodiment. The image forming apparatus 1400 includes the operating unit 10, the sensor 11, the load 12, the imaging unit 13, the fuser 14, and a startup controller 1410.

In the third embodiment, the function of the startup controller 1410 is different from that of the second embodiment. Specifically, functions of a CPU 1421 included in an engine controller 1420 in the startup controller 1410 and a return signal controller 1435 in the startup controller 1410 are different from those of the second embodiment. Otherwise, the image forming apparatus 1400 has the same configuration and operates in the same manner as the image forming apparatus 700 previously described in connection with FIG. 7. Therefore, like reference numerals refer to like parts, and the same explanations are not repeated.

It is different from the return signal controller 735 according to the second embodiment that the return signal controller 1435 further generates a return signal (hereinafter, “signal 3”) having a different strength corresponding to whether the non-operating time of the engine has exceeded a predetermined specified value.

The return signal controller 1435 stores the time when an operation such as printing or FAX reception has finished in a storage unit (not shown), and at the time of returning from the power saving mode, calculates the non-operating time from a difference between the return time and the stored time. The return signal controller 1435 then determines whether the non-operating time has exceeded a specified value by comparing the calculated non-operating time with the predetermined specified value.

The return signal controller 1435 is connected to the CPU 1421 not only via the data lines 51 and 52 for sending signals 1 and 2 but also via a data line 53 for sending signal 3.

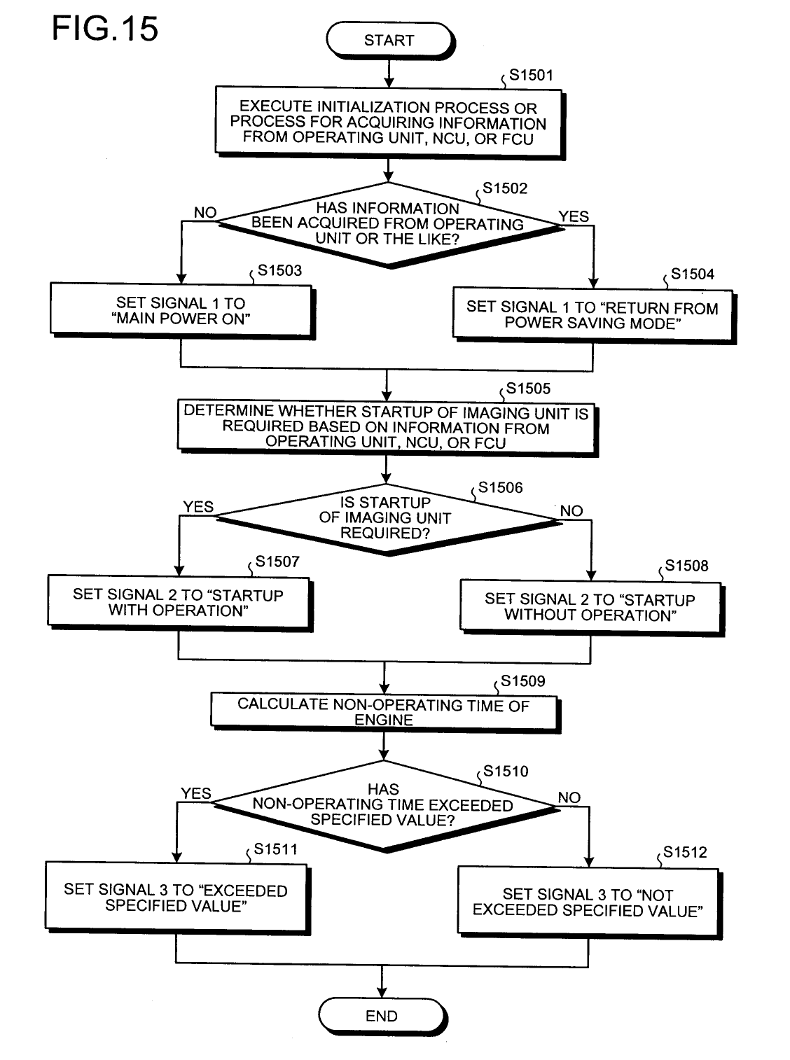

The return-signal setting process performed by the image forming apparatus 1400 is explained next. FIG. 15 is a flowchart of the return-signal setting process according to the third embodiment.

The setting process of signal 1 and the setting process of signal 2 at steps S1501 to S1508 are the same as the process at steps S801 to S808 described previously in the second embodiment, and therefore, explanations thereof are omitted.

After having set signal 2, the return signal controller 1435 calculates the non-operating time of the engine (step S1509). Specifically, the return signal controller 1435 calculates the non-operating time by obtaining a difference between the time at the time of finishing the engine operation, which has been stored beforehand, and the current time.

The return signal controller 1435 then determines whether the non-operating time has exceeded the predetermined specified value (step S1510). When the non-operating time has exceeded the specified value (YES at step S1510), the return signal controller 1435 sets signal 3 to “exceeded specified value” (step S1511). When the non-operating time does not exceed the specified value (NO at step S1510), the return signal controller 1435 sets signal 3 to “not exceeded specified value” (step S1512).

When the main power is turned on, because the time at the time of finishing the engine operation, which has been stored beforehand, is not present, the return signal controller 1435 cannot calculate the non-operating time. In this case, signal 3 is set to “not exceeded specified value”, and determination of the non-operating time is performed after the command open state has been established (step S407).

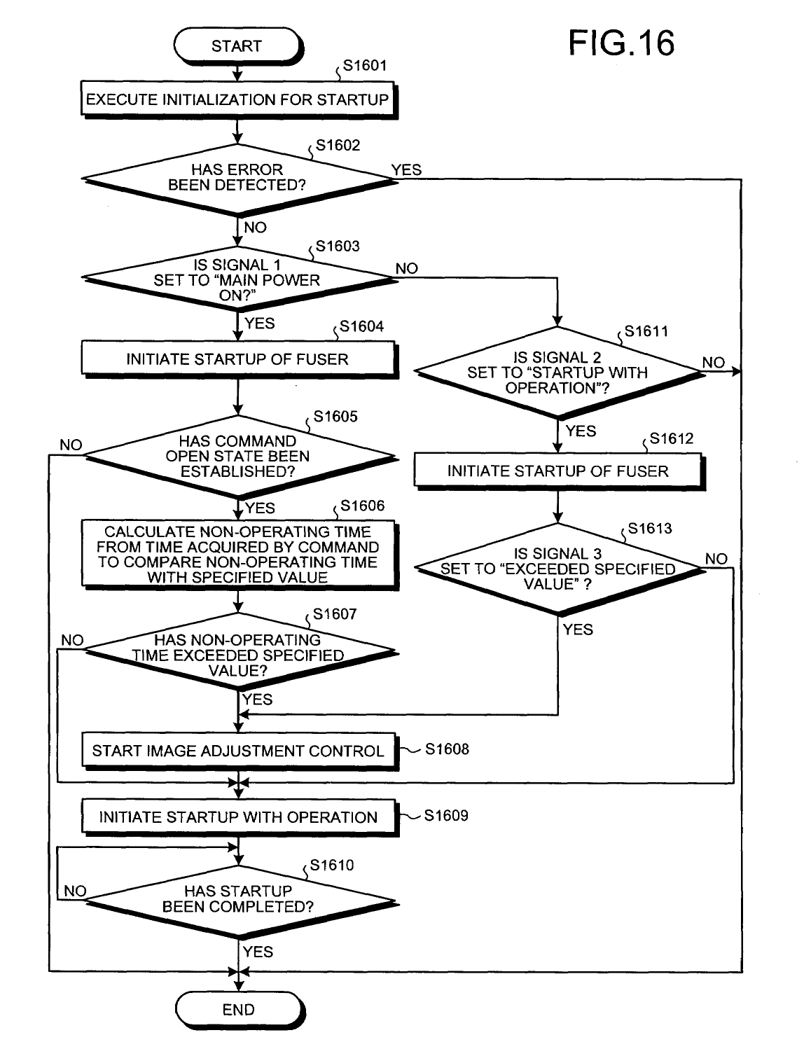

The startup process by a return signal is explained next. FIG. 16 is a flowchart of the startup process by a return signal according to the third embodiment.

The initialization process, the error detection process, the command open-determination process, the image adjustment-control process, and a startup initiating process with operations at steps 1601 to S1610 are the same as those at steps S901 to step S910 shown in FIG. 9. Therefore, explanations thereof are omitted.

When it is determined that signal 1 is not set to “main power ON” (NO at step S1603), the CPU 1421 determines whether signal 2 is set to “startup with operation” (step S1611).

When signal 2 is set to “startup with operation” (YES at step S1611), the CPU 1421 initiates startup of the fuser 14 (step S1612). The CPU 1421 then determines whether signal 3 is set to “exceeded specified value” (step S1613). When signal 3 is set to “exceeded specified value” (YES at step S1613), the CPU 1421 starts the image adjustment control (step S1608).

When signal 3 is set to “not exceeded specified value”, (NO at step S1613), the CPU 1421 initiates startup with an operation (step S1609).

When it is determined that signal 2 is not set to “startup with operation” (NO at step S1611), the CPU 1421 finishes the startup process with an operation.

The startup process by a command according to the third embodiment is the same as that according to the first embodiment shown in FIG. 4, and therefore, explanations thereof are omitted.

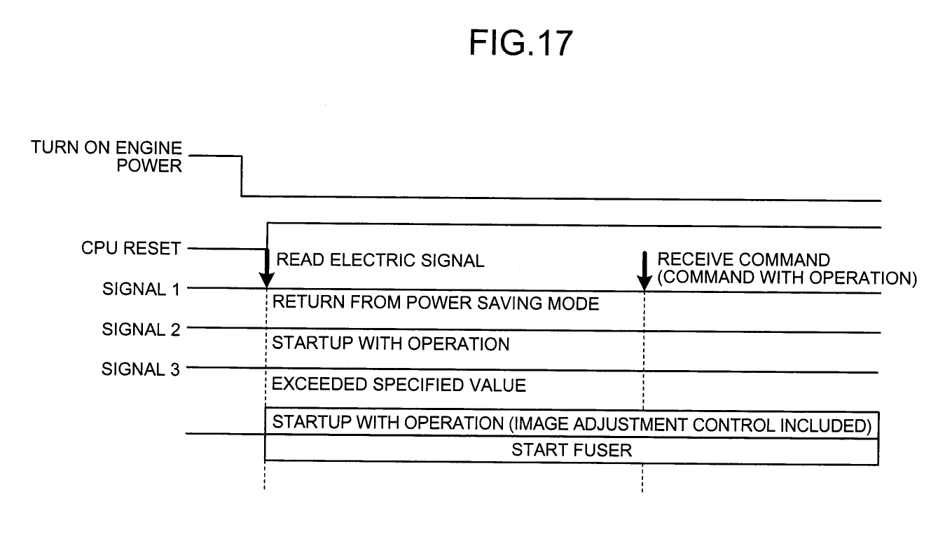

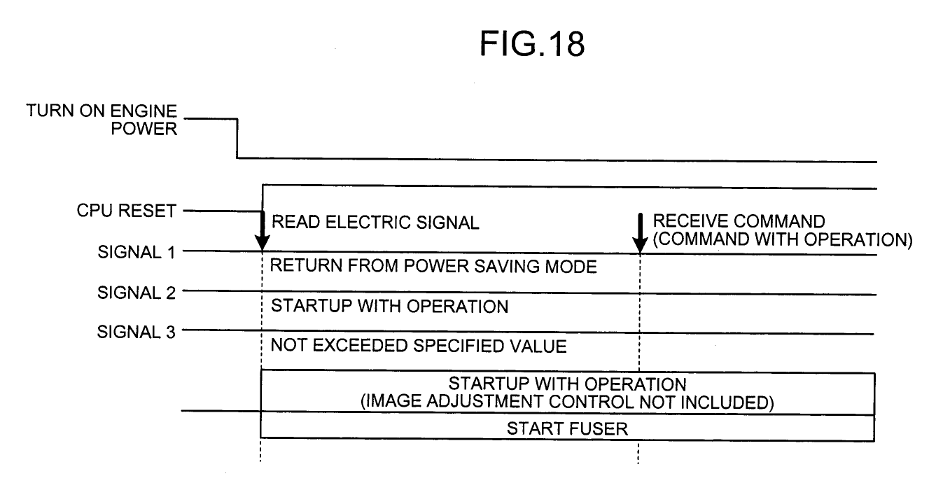

A specific example of the engine-startup control process performed by the image forming apparatus 1400 is explained. FIGS. 17 and 18 are an example of the signal and the command handled in the startup control process.

FIG. 17 is an example of the signal and the command at the time of returning from the power saving mode and when the non-operating time of the engine exceeds the specified value.

For example, when the apparatus returns from the power saving mode upon receipt of a human operation such as button operation or opening a cover by the user, a print request, or a FAX reception request received by the operating unit 10, signal 1 is set to “return from power saving mode”, and signal 2 is set to “startup with operation”, and if the non-operating time has exceeded the specified value, signal 3 is set to “exceeded specified value”. This case corresponds to the example shown in FIG. 17.

As shown in FIG. 17, the power of the engine is turned on, and after the CPU 1421 is reset, the CPU 1421 reads signal 1 to signal 3 set by the return signal controller 1435.

In this example, because signal 1 is set to “return from power saving mode”, signal 2 is set to “startup with operation”, and signal 3 is set to “exceeded specified value”, the CPU 1421 initiates startup of the fuser 14 (YES at step S1503, YES at step S1511, step S1512), and starts the image adjustment control (YES at step S1513, step S1508).

Thus, according to the third embodiment, because it can be determined whether the image adjustment control is required by referring to signal 3 related to the non-operating time, it is not necessary to wait for the establishment of the command open state to acquire the time, and therefore startup of the imaging unit 13 can be started early. Accordingly, the startup time can be reduced, and reduction of the waiting time of the user can be realized.

FIG. 18 is an example of the signal and the command at the time of returning from the power saving mode and when the non-operating time of the engine does not exceed the specified value. As shown in FIG. 18, the power of the engine is turned on, and after the CPU 1421 is reset, the CPU 1421 reads signal 1 to signal 3 set by the return signal controller 1435.

In this example, because signal 1 is set to “return from power saving mode”, signal 2 is set to “startup with operation”, and signal 3 is set to “not exceeded specified value”, the CPU 1421 initiates startup of the fuser 14 (YES at step S1503, YES at step S1511, step S1512), and initiates startup with an operation without starting the image adjustment control (NO at step S1513, step S1509).

Thus, because it can be determined whether the image adjustment control is required by referring to signal 3 related to the non-operating time, the image adjustment control is not executed uselessly, ad startup of the imaging unit 13 can be appropriately executed.

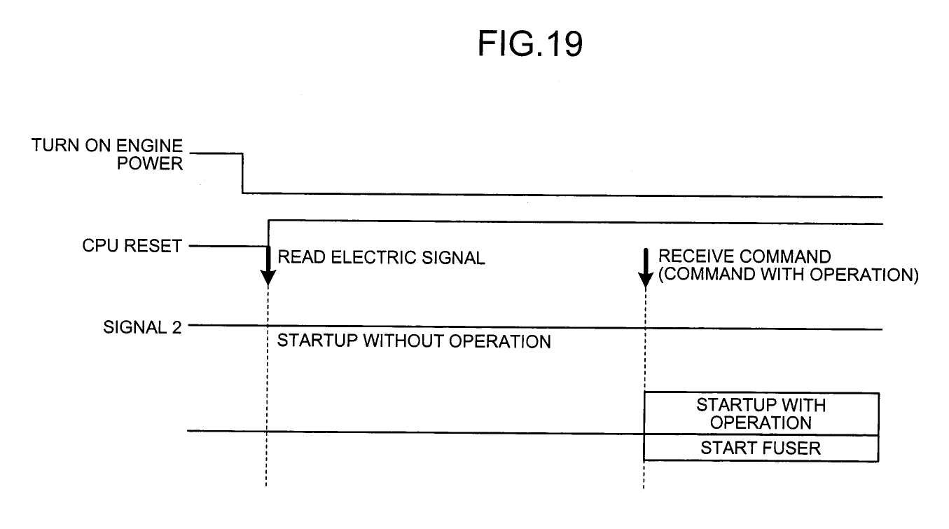

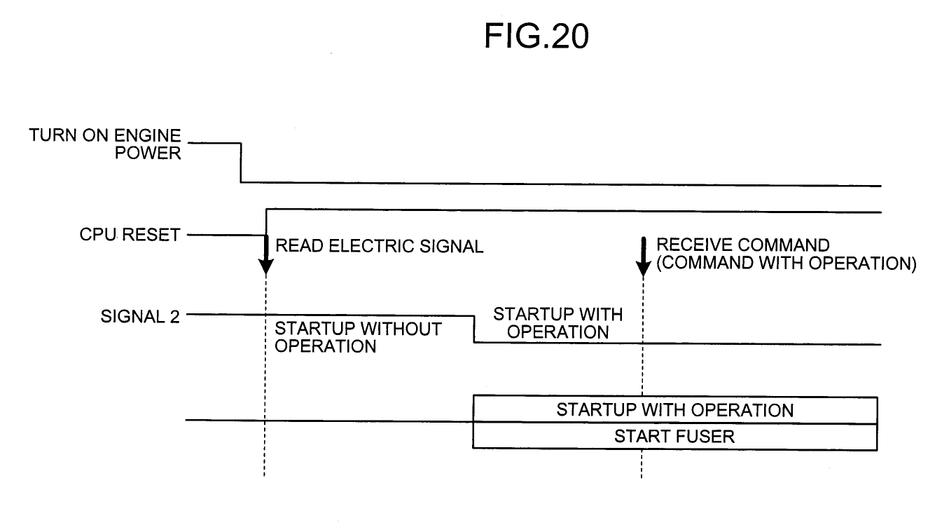

Another example of the engine-startup control process performed by the image forming apparatus 1400 is explained. FIGS. 19 and 20 are another example of the signal and the command handled in the startup control process. FIGS. 19 and 20 are an example of the startup control process when a startup type (startup with an operation or startup without an operation) is changed after starting the startup.

FIG. 19 is an example in which a startup request by a return signal is different from a startup request by a command. Specifically, an example is shown in which because signal 2 is set to “startup without operation”, startup of the imaging unit 13 and the fuser 14 is not executed, however, startup with an operation is requested in a startup request by a command received after the command open state has been established.

In this case, startup with an operation (startup of the imaging unit 13 and the fuser 14) is started according to the command request issued later.

FIG. 20 is an example in which a startup request by a return signal is further sent after the startup request by a return signal. Specifically, an example is shown in which because the initially received signal 2 is set to “startup without operation”, startup of the imaging unit 13 and the fuser 14 is not executed, however, signal 2 set to “startup with operation” is received afterwards.

For example, a corresponding case is such that a startup request of the image forming apparatus 1400 has been received via the network, however, signal 2 is set to “startup without operation” because a process to be executed is unclear, and thereafter, it is found that the process to be executed is, for example, printing, and startup of the imaging unit 13 is required.

In this case, startup with an operation (startup of the imaging unit 13 and the fuser 14) is started according to a request of signal 2 issued later. Thus, an appropriate startup control process corresponding to a situation can be realized by referring to the return signal, without using the command.

As described above, according to the third embodiment, startup control is basically performed based on signal 1, signal 2, and signal 3, which are return signals, and thereafter, upon receipt of a startup request by a command, startup control is performed based on the command.

In such a configuration, for example, there is such a situation that after having initiated startup of the fuser 14 according to the startup control by a return signal, when it is found that the process is only to receive a FAX message and store it in an HDD, startup of the fuser 14 needs to be cancelled. Therefore, in a case that the FAX message is received at night, there can be a problem such that noise is generated due to useless startup of the fuser 14.

To avoid such a problem, it can be configured such that the user can set to which of the startup control by a return signal and startup control by a command is given priority, and either one of the startup control methods is applied according to the setting.

As for the setting, conventionally used various methods such as a method of receiving setting information input by the user by the operating unit 10 and a method of receiving the setting information input by the user from an external device connected by the network via the NCU 33 can be used.

According to the third embodiment, the image forming apparatus further sends an electric signal indicating whether the non-operating time of the engine has exceeded the predetermined threshold, thereby enabling control of the startup of the engine according to the electric signal. Accordingly, the image adjustment process can be started without waiting for a request from the controller, thereby reducing the startup time to reduce the waiting time of the user.

According to the first to the third embodiments, to notify the startup state, electric signals (signal 1, signal 2, and signal 3) are sent by using the data lines 51, 52, and 53, respectively. However, the notification method of the startup state is not limited thereto, and any notification method conventionally used such as a peripheral component interconnect bus (PCI bus) can be applied. In this case, the image forming apparatus is configured such that notification of the startup state is executed prior to the command notification by the bus between the controller 31 and a CPU. Accordingly, engine startup can be initiated without waiting for a request from the controller, which reduces the startup time.

As set forth hereinabove, according to an embodiment of the present invention, startup of the device can be appropriately controlled based on the startup state, which reduces the startup time. Moreover, appropriate startup control can be performed based on an instruction from a user. Furthermore, images can be adjusted, which improves the quality of the images.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A startup controller comprising:
a first controller that is connected to a device that performs mechanical operation, and controls the device;
a second controller that establishes communication with the first controller, and controls process related to the device through established communication; and
an information sending unit that is connected to the first controller, and sends first information related to a startup state of the device to the first controller, wherein
the first controller controls startup of the device based on the first information received from the information sending unit before the second controller establishes the communication.

2. The startup controller according to claim 1, wherein
the first information indicates that power is turned on, or that a command to return from power saving mode is received at standby, less power being consumed in the power saving mode, and
the first controller starts up the device when the first information indicates that power is turned on.

3. The startup controller according to claim 2, wherein the first controller does not start up the device when the first information indicates that a command to return from power saving mode is received.

4. The startup controller according to claim 1, wherein
the first information indicates that whether the mechanical operation is required to be performed, and
the first controller starts up the device such that the mechanical operation is to be performed when the first information indicates that the mechanical operation is required.

5. The startup controller according to claim 1, wherein
the first information indicates whether a time period during which the device has not operated exceeds a predetermined threshold, and
the first controller starts up the device when the first information indicates that the time period exceeds the predetermined threshold such that process to be performed when the time period exceeds the predetermined threshold is to be performed.

6. The startup controller according to claim 1, wherein
the second controller sends second information to request to start up the device to the first controller through the established communication, and
the first controller controls the startup of the device based on the second information.

7. The startup controller according to claim 6, wherein, upon receiving the second information after the first information, the first controller controls the startup of the device based on the second information.

8. The startup controller according to claim 1, wherein
the information sending unit sends second information that is related to the startup state of the device and different from the first information to the first controller after sending the first information to the first controller, and
upon receiving the second information after the first information, the first controller controls the startup of the device based on the second information.

9. The startup controller according to claim 1, wherein
the information sending unit is connected to the first controller via a signal line, and sends the first information that indicates the startup state of the device by strength of an electric signal to the first controller through the signal line.

10. The startup controller according to claim 1, wherein the information sending unit is connected to the first controller via a bus including a plurality of signal lines, and sends the first information to the first controller through the bus.

11. The startup controller according to claim 6, further comprising a receiving unit that receives a command input through an input unit and instructing to control the startup of the device based on any one of the first information and the second information, wherein
the first controller controls the startup of the device based on any one of the first information and the second information according to the command.

12. The startup controller according to claim 6, further comprising a receiving unit that receives a command transmitted through a network and instructing to control the startup of the device based on any one of the first information and the second information, wherein
the first controller controls the startup of the device based on any one of the first information and the second information according to the command.

13. An image forming apparatus comprising:
an image forming unit that forms an image on an image carrier;
a fixing unit that fixes the image formed by the image forming unit on a recording medium; and
a startup controller that controls startup of the image forming unit and the fixing unit, and includes
a first controller that controls mechanical operation of the image forming unit and the fixing unit;
a second controller that establishes communication with the first controller, and controls process related to the image forming unit and the fixing unit through established communication; and
an information sending unit that is connected to the first controller, and sends first information related to a startup state of the image forming unit and the fixing unit to the first controller, wherein
the first controller controls the startup of the image forming unit and the fixing unit based on the first information received from the information sending unit before the second controller establishes the communication.

14. The image forming apparatus according to claim 13, wherein
the first information indicates that power is turned on, or that a command to return from power saving mode is received at standby, less power being consumed in the power saving mode, and
the first controller starts up the fixing unit when the first information indicates that power is turned on.

15. The image forming apparatus according to claim 14, wherein the first controller does not start up the fixing unit when the first information indicates that a command to return from power saving mode is received.

16. The image forming apparatus according to claim 13, wherein
the first information indicates that whether the mechanical operation of the image forming unit is required to be performed, and
the first controller starts up the image forming unit such that the image forming unit performs the mechanical operation when the first information indicates that the mechanical operation is required.

17. The image forming apparatus according to claim 16, further comprising an image adjusting unit that adjusts the image formed by the image forming unit.

18. The image forming apparatus according to claim 17, wherein
the second controller sends second information to request to start up the image forming unit and the fixing unit to the first controller through the established communication, and
the image adjusting unit adjusts the image formed by the image forming unit after receipt of the second information sent from the second controller.

19. The image forming apparatus according to claim 17, wherein
the first information indicates whether a time period during which the image forming unit has not operated exceeds a predetermined threshold, and
the image adjusting unit adjusts the image formed by the image forming unit when the first information indicates that the time period exceeds the predetermined threshold.

20. A startup control method that is applied to a startup controller including a first controller that is connected to a device that performs mechanical operation and controls the device, a second controller that establishes communication with the first controller and controls process related to the device through established communication, and an information sending unit that is connected to the first controller, the startup control method comprising:
the information sending unit sending information related to a startup state of the device to the first controller; and
the first controller controlling startup of the device based on the first information received from the information sending unit before the second controller establishes the communication.
